(19) United States
(12) Patent Application Publication
(10) Pub. No.: US 2006/0239027 A1
(43) Pub. Date: Oct. 26, 2006

(54) Backlight module

(75) Inventor: Chien-Hsiang Chen, Chu-Nan (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/401,361

(22) Filed: Apr. 11, 2006

(30) Foreign Application Priority Data
Apr. 22, 2005 (TW) 94112913

(51) Int. Cl. F21V 7/04

(52) U.S. Cl. 362/600

(57) ABSTRACT

A backlight module comprising a light guide plate, a lamp reflector and a lamp for providing a light is provided. The light guide plate includes a side end, an upper surface, and a lower surface. The light provided by the lamp enters the light guide plate through the side end and is provided outward through the upper surface. The lamp reflector is disposed at the side end to enclose the lamp. The lamp reflector comprises an upper flake and a lower flake to clamp the light guide plate. An angle exists between a extended direction of the upper flake and a extended direction of the lower flake.

### BACKGROUND OF THE INVENTION

(1) Field of the Invention

The present invention generally relates to a backlight module and particularly relates to a lamp reflector of the backlight module.

(2) Description of the Prior Art

A panel display, such as a liquid crystal display (LCD), becomes more and more popular in a market, requirement of a backlight module, which provides a backlight source for the panel display, is therefore enhanced.

Please refer to FIG. 1, which illustrates a cross section view of a conventional backlight module. The backlight module 2 comprises a lamp 6, a light guide plate 4, a lamp reflector 8 and a reflecting sheet 10.

The lamp 6 is for providing a light. The light guide plate 4 receives the light provided by the lamp 6 through a side end 41. The light is scattered within the light guide plate 4 so as to be provided outward uniformly through an upper surface 42 of the light guide plate 4. The lamp reflector 8 is disposed at the side end 41 and combined with the light guide plate 4. The lamp 6 is enclosed by the lamp reflector 8 and the side end 41, so the light provided by the lamp 6 is able to be highly used to enter the light guide plate 4. Similarly, the reflecting sheet 10 disposed at a lower surface 43 of the light guide plate 4 is also adopted to raise the light-utilized percentage of the backlight module 2.

The lamp reflector 8 includes an upper flake 802 and a lower flake 804. The upper flake 802 and the lower flake 804 are substantially parallel to each other. Typically, a predetermined distance between the upper flake 802 and the lower flake 804 is precisely equal to a thickness of the light guide plate 4.

The predetermined distance, which is precisely equal to the thickness of the light guide plate 4, is for preventing a resulted gap between the light guide plate 4 and the lamp reflector 8 from causing a leak of the light. However, it brings an inconvenience for combining the light guide plate 4 with the lamp reflector 8.

Besides, the side end 41 of the light guide plate 4 has an upper margin area 411 and a lower margin area 412. The light entering through the upper margin area 411 or the lower margin area 412 is likely to form a bright line (shown as Le). The bright line is a particularly brighter area, which forms a line shape or a band shape, shown on the upper surface 42 of the light guide plate 4 and near the lamp 6. Of course, the bright line defeats an optical uniform of the backlight module 2. This undesired bright line usually appears in a V-cut typed backlight module, which applies a light guide plate with V-cut patterns on the lower surface or upper surface.

A prior art as U.S. Pat. No. 6,406,158 utilizes slopes structure on the lower surface of the light guide plate to prevent the bright line. However, forming this kind of specific structure on the light guide plate requires extremely machining accuracy, which leads to additional cost and extra fabrication processes.

### SUMMARY OF THE INVENTION

An objective of the present invention is to provide a backlight module, which has a structure for combining a light guide plate with the lamp reflector easier.

Another objective of the present invention is to provide a backlight module capable of improving the conventional bright line drawback.

Another objective of the present invention is to provide a backlight module having a remaining ability of a leak of a light preventing.

Another objective of the present invention is to provide a backlight module, which is economic to fabricate.

A backlight module comprises a light guide plate, a lamp reflector and a lamp for providing a light. The light guide plate includes a side end, an upper surface a lower surface. The light provided by the lamp enters the light guide plate through the side end and is provided outward through the upper surface. The lamp reflector is disposed at the side end to enclose the lamp. The lamp reflector comprises an upper flake and a lower flake to clamp the light guide plate. A predetermined included angle exists between extended directions of the upper flake and the lower flake.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

The present invention will now be specified with reference to its preferred embodiment illustrated in the drawings.

FIG. 1 illustrates a cross section view of a conventional backlight module.

FIG. 2 shows a cross section view of parts of a present backlight module according to a first embodiment.

FIG. 3 shows a cross section view of parts of a present backlight module according to a second embodiment.

FIG. 4 shows a cross section view of parts of a present backlight module according to a third embodiment.

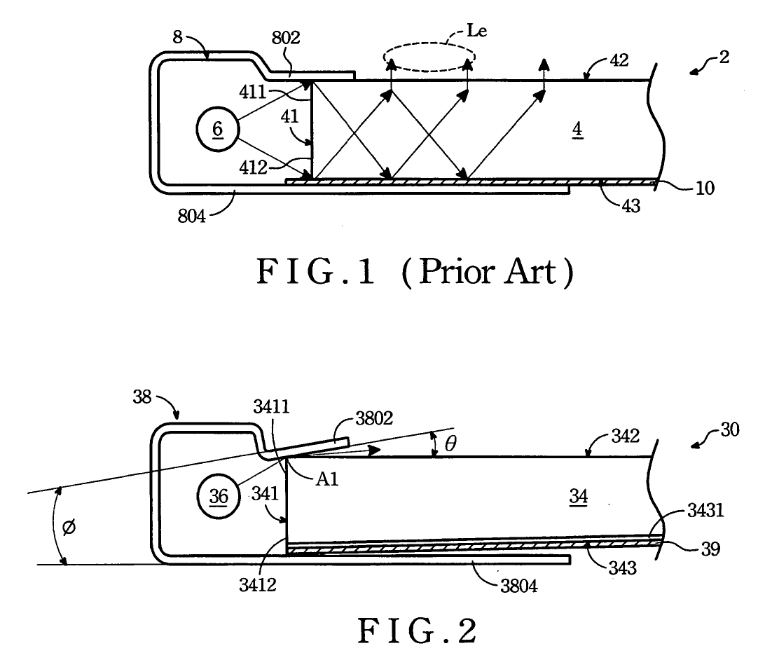

### DESCRIPTION OF THE PREFERRED EMBODIMENT

To reach the mentioned objectives, the present invention provides several embodiments with corresponding drawings to illustrate the means and the obtained functions.

### The First Embodiment

Please refer to FIG. 2. The present backlight module 30 comprises a lamp 36, a light guide plate 34, a lamp reflector 38 and a reflecting sheet 39.

The lamp 36 is for providing a light. The light guide plate 34 includes a side end 341, an upper surface 342 and a lower surface 343. The light guide plate 34 receives the light provided by the lamp 36 through the side end 341. The light is scattered within the light guide plate 34 so as to be provided outward uniformly through the upper surface 342 of the light guide plate 34. A plurality of V-cut patterns is formed on the lower surface 343 or upper surface 342 to control the uniformity of outward provided light and to enhance the brightness. In the embodiment, the V-cut patterns are formed on the lower surface 343. The lamp reflector 38 is disposed at the side end 341 and combined with the light guide plate 34. The lamp 36 is enclosed by the lamp reflector 38 and the side end 341, so the light provided from the lamp 36 is able to enter the light guide plate 34 with a high percentage. That is, the light reflected by the lamp reflector 38 is able to be changed a direction of the light to enter the light guide plate 34. The reflecting sheet 39 disposed on the lower surface 343 of the light guide plate 34 is also adopted to raise a light-utilized percentage of the backlight module 30.

The light guide plate 34 has a first corner (A1) and a second corner (A2). The first corner (A1) is where the upper surface 342 and the side end 341 join, and the second corner (A2) is where the side end 341 and the lower surface 343 join. The lamp reflector 38 includes an upper flake 3802 and a lower flake 3804 to clamp the light guide plate 34. The upper flake 3802 is in touch with the first corner (A1), and the lower flake 3804 is in touch with the second corner (A2). The upper flake 3802 and the lower flake 3804 are not parallel to each other. There is a predetermined included angle φ between an extended direction of the upper flake 3802 and an extended direction of the lower flake 3804. Being closer to the lamp 36, the distance between the upper flake 3802 and the lower flake 3804 is more reduced. In this structure, the fabrication step of combining the lamp reflector 38 with the light guide plate 34 becomes much more easier than the conventional backlight module.

Mean while, this structure will not result in any gap between the combined portion of the light guide plate 34 and the lamp reflector 38. So the ability of preventing a leak of the light of the present invention is also remarkable as the mentioned conventional backlight module. Besides, the reduced distance between the upper flake 3802 and the lower flake 3804 is helpful to the prior drawback of bright line. The bright line is resulted from the entered light through the upper margin area 3411 or the lower margin area 3412. In the present invention, take the upper flake 3802 for example, the upper flake 3802 has an angle θ corresponding to the upper surface 342 of the light guide plate 34. The upper flake 3802 can changes the reflective direction of the light entering the upper margin area 3411. Through observation, the drawback of the bright line is thus avoided according to this embodiment.

Furthermore, to fabricate the present lamp reflector 38 as shown in FIG. 2 only need similar punching machining process as the conventional lamp reflector. No additional material or fabricating process is needed in the present invention.

### The Second Embodiment

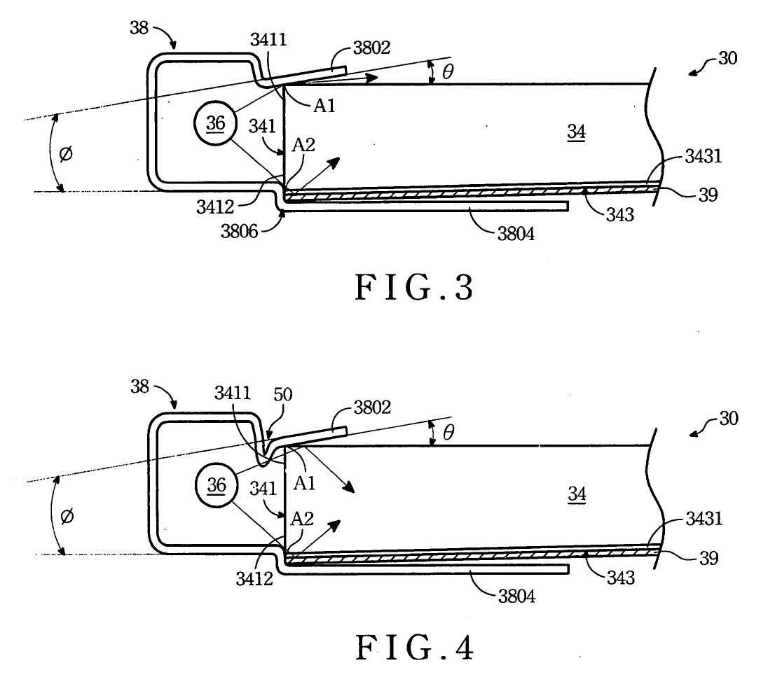

Please refer to FIG. 3. Comparing with the first embodiment, the lamp reflector 38 of the second embodiment further comprises a lower banding structure 3806, which connects with the lower flake 3804. The upper flake 3802 and the lower flake 3804 clamp the light guide plate 34. The lower banding structure 3806 is used for accommodating the second corner (A2). The upper flake 3802, which has the angle θ corresponding to the upper surface 342, and is in touch with the first corner (A2).

The upper flake 3802 can changes the reflective direction of the light entering the upper margin area 3411 to avoid the bright line drawback. In addition, the lower banding structure 3806 can cover the lower margin area 3412 to prevent light from entering. This can further avoid the drawback of the bright line.

### The Third Embodiment

Please refer to FIG. 4. Comparing with the second embodiment, the lamp reflector 38 of the third embodiment further comprises a upper banding structure 50, which connects with the upper flake 3802. The upper flake 3802 and the lower flake 3804 clamp the light guide plate 34. The lower banding structure 3806 is used for accommodating the second corner (A2). The upper banding structure 50 is used for accommodating the first corner (A1). The upper flake 3802 has the angle θ corresponding to the upper surface 342.

The upper flake 3802 can changes the reflective direction of the light entering the upper margin area 3411 to improve the bright line drawback. The lower banding structure 3806 can cover the lower margin area 3412 to prevent light from entering, so as to further improve the bright line drawback. In addition, the upper banding structure 50 can cover the upper margin area 3411 to prevent light from entering. By these, the bright line is well prevented.

Furthermore, to fabricate the present lamp reflector 38 as shown in FIG. 2 only need similar punching machining process as the conventional lamp reflector. No additional material or fabricating process is needed in the present invention.

With the example and explanations above, the features and spirits of the invention are hopefully well described. Those skilled in the art will readily observe that numerous modifications and alterations of the device may be made while retaining the teaching of the invention. Accordingly, the above disclosure should be construed as limited only by the metes and bounds of the appended claims.

I claim:

1. A backlight module, comprising:
a lamp for providing a light;
a light guide plate, including a side end, an upper surface, and a lower surface, the light guide plate disposed to receive the light provided by the lamp through the side end, the light scattered within the light guide plate so as to be provided outward uniformly through the upper surface, wherein the light guide plate further include a first corner and a second corner, the first corner being where the upper surface and the side end join, the second corner being where the side end and the lower surface join; and
a lamp reflector, disposed at the side end and combined with the light guide plate, the lamp being enclosed by the lamp reflector and the side end, wherein the lamp reflector comprises an upper flake being in touch with the first corner and having an angle (θ) corresponding to the upper surface.

2. The backlight module according to claim 1, wherein the lamp reflector further comprises a lower flake and a lower banding structure connecting with the lower flake, the lower banding structure accommodating the second corner, the lower banding structure covering a lower margin area of the side end to prevent light from entering.

3. The backlight module according to claim 1, wherein the lamp reflector further comprises a upper banding structure connecting with the upper flake, the upper banding structure covering an upper margin area of the side end to prevent light from entering.

4. The backlight module according to claim 1, wherein the lamp reflector comprises an upper flake and a second flake to clamp the light guide plate, wherein a predetermined included angle (φ) exists between an extended direction of the upper flake and an extended direction of the lower flake.

5. The backlight module according to claim 1, wherein a plurality of V-cut patterns is formed on the lower surface or upper surface of the light guide plate.

6. A backlight module, comprising:
a lamp for providing a light;
a light guide plate, including a side end, an upper surface, and a lower surface, the light guide plate disposed to receive the light provided by the lamp through the side end, the light scattered within the light guide plate so as to be provided outward uniformly through the upper surface, wherein the light guide plate further includes a first corner and a second corner, the first corner is where the upper surface and the side end join, the second corner being where the side end and the lower surface join; and
a lamp reflector, disposed at the side end and combined with the light guide plate, the lamp being enclosed by the lamp reflector and the side end, wherein the lamp reflector comprises an upper flake and a lower flake to clamp the light guide plate, wherein a predetermined included angle (φ) exists between extended directions of the upper flake and the lower flake.

7. The backlight module according to claim 6 further comprises a reflecting sheet disposed on the lower surface of the light guide plate.

8. The backlight module according to claim 6, wherein the upper flake is in touch with the first corner and has an angle (θ) corresponding to the upper surface.

9. The backlight module according to claim 6, wherein the lamp reflector further comprises a lower banding structure connecting with the lower flake, the lower banding structure receiving the second corner, the lower banding structure covering a lower margin area of the side end to prevent light from entering.

10. The backlight module according to claim 6, wherein the lamp reflector further comprises a upper banding structure connecting with the upper flake, the upper banding structure covering an upper margin area of the side end to prevent light from entering.

11. The backlight module according to claim 6, wherein a plurality of V-cut patterns is formed on the lower surface of the light guide plate.
